(19) United States
(12) Patent Application Publication
(10) Pub. No.: US 2004/0055543 A1
(43) Pub. Date: Mar. 25, 2004

(54) Protective device for a horse

(76) Inventor: Valery Clement, Fillinge (FR)

Correspondence Address: OLSON & HIERL, LTD., 20 North Wacker Drive, 36th Floor, Chicago, IL, 60606, US

(21) Appl. No.: 10/666,718

(22) Filed: Sep. 18, 2003

(30) Foreign Application Priority Data
Sep. 25, 2002 (EP) EP 02102384.1

(51) Int. Cl. A01K 13/00

(52) U.S. Cl. 119/850; 119/856

(57) ABSTRACT

A protective device for protecting the hind legs of horses, shaped to the rear part of the end of the limb. This device comprises a rigid casing, a padded lining and retaining straps and rises up above the bend of the joint of the limb, the rigid casing resting above the limb joint.

### RELATED APPLICATION

This application is based upon European Patent Application No. EP 02102384.1 filed Sep. 25, 2002, for which priority is claimed.

### BACKGROUND OF THE INVENTION

1. Field of the Invention

The invention relates to devices intended to prevent injury to the legs of horses particularly during transport.

The invention relates more particularly to the protecting of the hind legs of horses.

2. Description of the Prior Art

BE 1012706 and DE 20106800 disclose flexible or rigid devices protecting the tendons, which do not impede the horse's freedom of movement.

These flexible transport protections, generally made of textile, do not adequately absorb knocks, afford barely any protection to the tissues and have a tendency to slip down.

These devices—while they prevent injury to the front part of the legs, particularly as the horse moves its foot towards an obstacle—do not, however, offer any effective protection when the horse is parked in a travail or in a box.

Likewise, U.S. Pat. No. 1,395,689 discloses protections fitted around the fetlocks and the pasterns while leaving the horse's knees free.

U.S. Pat. No. 4,349,016 describes a splint for livestock. Such a splint, which is completely rigid, immobilizes the leg of a beast over its entire length and is therefore inappropriate for every day transport or for transporting a horse that is in good health.

The problem inherent to all the protective devices currently available in the marketplace is that they provide effective protection only to the front part of the legs, essentially the cannons, fetlocks and pasterns, when the horse swings its legs forward, or, at the limit, protects only the front limbs from being kicked by the hind hooves.

Now, it is found in practice that one part of the anatomy which suffers enormously during transport is the rear of the hock, which is never protected effectively.

The problem is that the limbs at this point are particularly lacking in flesh. Apart from the thin natural protection afforded by the skin and the hair, the Achilles tendon, the tendonous tissues and the cartilage are particularly exposed to knocks. Aside from the suffering that results from this, injury to this region causes the leg to loose mobility and has a detrimental effect on performance something which is particularly undesirable especially in the case of horses which compete in competitions.

The problem raised by producing a protection that goes up as far as the hocks is that such a protection is, by definition, very awkward to keep in place, and has the risk of being felt by the horse to be a true impediment, making the horse both clumsy and skittish, thus increasing the risk of accident and reducing performance after transport.

Attempts have been made at solving the above problems by producing a protection which is effective against knocks and bangs, stays in place well and is well tolerated by horses.

### SUMMARY OF THE INVENTION

The subject of the invention is a protective device for protecting the hind legs of horses. This device comprises a rigid casing, a padded lining, retaining straps. The device is shaped at the rear part of the end of the limb and goes up to above the bend of the limb joint, against which it rests, the rigid casing bearing above the limb joint.

The advantage with this arrangement is that the protection makes use of the anatomy of the hind leg to ensure that the protection is held in place effectively, without excessively impeding the movements of the leg and leaving the joint with sufficient mobility. In that way, the animal is protected against any contact, even violent contact, not only during transport, but also during the manoeuvres of getting the animal into and out of the transport and moving around afterwards, etc.

The presence of a rigid casing protects the horse from knocks which may be very violent against a wall, protruding objects, etc, while the padding both spreads and absorbs impacts and gives an overall comfortable feel in spite of the tightness of the fasteners.

The lower end of the protection advantageously comprises an articulated part corresponding to the fetlock joint.

The lower end of the protection preferably comprises, towards the front, a widened part corresponding to the flare of the hoof.

The retaining straps that hold the protection on are secured by being fastened to each other.

According to an advantageous embodiment, the casing is made of flexible plastic.

According to another advantageous embodiment the casing is made of fibre-reinforced polymer.

The materials of which the device is made preferably maintain their properties in a temperature range of between −20 and +45° C.

### BRIEF DESCRIPTION OF THE SEVERAL VIEWS

Other particulars and advantages of the invention will become apparent from the description hereinafter of some particular embodiments of the invention, reference being made to the attached drawings in which:

FIG. 1 is an overall perspective view of the two hind legs of a horse, one of which legs is fitted with the device of the invention.

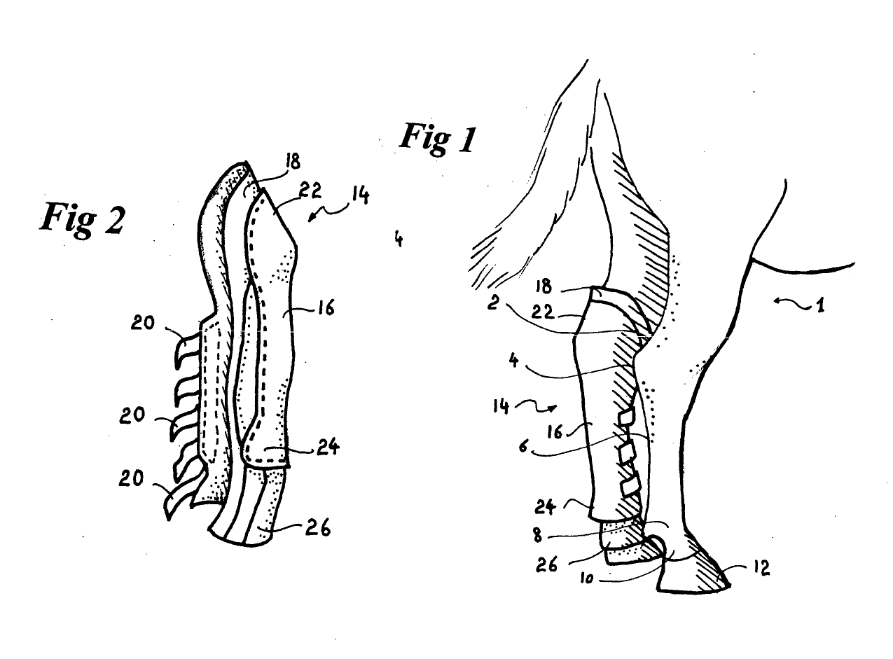

FIG. 2 is an overall perspective view of the device of the invention, open.

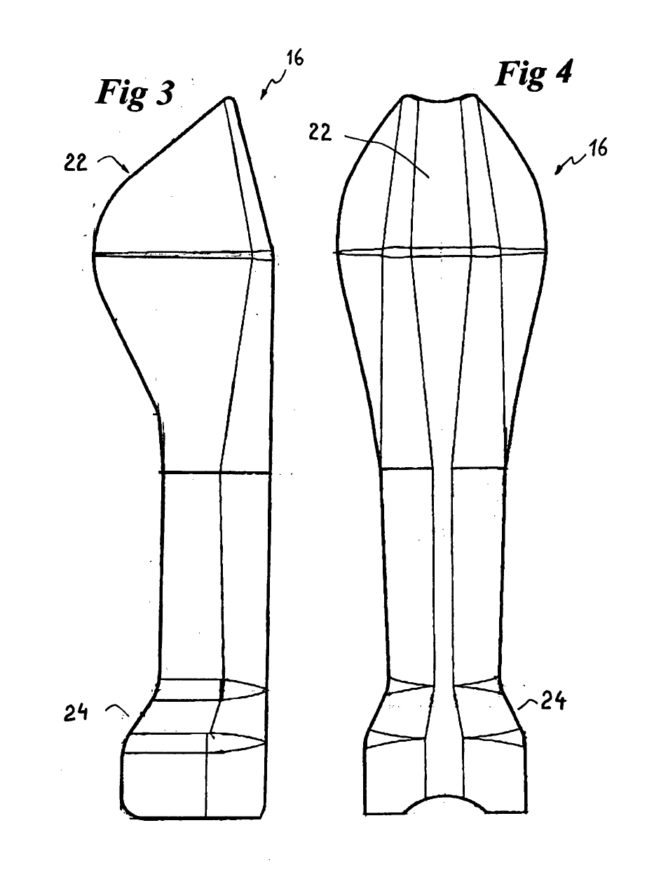

FIGS. 3 and 4 are profile and rear views of the casing of the device according to the invention.

### DETAILED DESCRIPTION OF THE DRAWINGS

Insufficient protection of the limbs may, in horses, in time, lead to irreversible lesions and boney growths—of the boney spur type—which may have a negative effect on sporting performance and the physical condition of the animal (for example: capped hock in trotters).

The injuries may delay the preparation of a horse for a sports event, or even see it eliminated therefrom.

The protection in its novel idea is designed to reduce the risk of injury caused by inadvertent pressure during transport, repeated knocks—because an agitated horse bangs against the walls—various instances of rubbing, or, more often than might be believed, poor fitting-out of the travelling space that a horse needs.

FIG. 1 shows the various parts of the hinge leg of the horse, namely, starting from the leg 1 proper, the Achilles tendon 2, the hock 4, the cannon 6, the fetlock 8, the pastern 10 and the hoof 12.

The protective device of the invention 14 covers the rear part of the left hind leg. It comprises a rigid casing 16 running along the cannon 6 and extending above the bend of the hock joint 4.

The presence of a padded internal lining 18 and of straps 20 allows the protection to be fastened around the cannon.

The flexible part rises up above the hock and is anatomically shaped so as not to impede the animal in its walk. It is made of a strong material so that it does not tear and so that it can, without problem, withstand the rubbing generated by pressure in transport and thus avoid premature wear.

The moulded plastic casing 16 is attached to the flexible part, behind the latter. It assumes a shape that is tailored to the anatomy of the animal, and is made of a material that is flexible enough to deform and deaden shocks but nonetheless strong enough not to break or crack, while at the same time being able to withstand variations in temperature (−20° C. +45° C.). As can be seen in FIGS. 3 and 4, the casing may comprise stiffening surfaces which, without increasing its weight, give it better mechanical strength.

At its upper part, the rigid casing 16 has a part which is both curved and flared 22, which fits over the curve of the limb, thereby giving this part which naturally is poorly protected protection against knocks and bangs and in addition preventing the device from working its way down along the limb or from turning.

As can be seen best in FIG. 2, the device is continued downward by a second flared part 24 fitting over the fetlock 8. This second flared part 24 also contributes to keeping the protection vertically in place.

The break in the rigid casing at the fetlock allows the horse not to feel too uncomfortable given that it can still flex its joints.

The lower end 26 of the padded part can be fitted using straps to the top of the hooves, this also playing a part in preventing the protection from slipping down and avoiding it rubbing against the hock.

The straps are advantageously lined with pieces that adhere to one another (of the Velcro® type), but obviously recourse may be had to conventional buckles or elasticized straps.

What is claimed:

1. A protective device for protecting the hind legs of a horse, which comprises a rigid casing
a padded lining
retaining straps
this device being shaped to the rear part of the cannon and, when fastened in place, rising up to above the bend of the limb joint, the rigid casing bearing above the limb joint against which it rests.

2. A protective device according to claim 1, wherein a lower end of the protection comprises an articulated part corresponding to the fetlock joint.

3. A protective device according to claim 1, wherein a lower end of the protection comprises, towards the front, a widened part corresponding to a flare of the hoof.

4. A protective device according to claim 2, wherein a lower end of the protection comprises, towards the front, a widened part corresponding to the flare of the hoof.

5. A protective device according to claim 1, wherein the retaining straps that hold the protection on are secured by being fastened to each other.

6. A protective device according to claim 1, wherein the casing is made of flexible plastic.

7. A protective device according to claim 1, wherein the casing is made of fibre-reinforced polymer.

8. A protective device according to claim 6, wherein the materials of which it is made maintain their properties in a temperature range of between −20 and +45° C.

9. A protective device according to claim 7, wherein the materials of which it is made maintain their properties in a temperature range of between −20 and +45° C.

10. A protective device according to claim 1, wherein the materials of which the rigid casing is made maintain their properties in a temperature range of between −20 and +45° C.
